(19) United States
(12) Patent Application Publication
(10) Pub. No.: US 2012/0093571 A1
(43) Pub. Date: Apr. 19, 2012

(54) Cutter mat coupling device

(75) Inventor: Fang Chi Yeh, Taipei (TW)

(73) Assignee: Le Summit Industrial Co., Ltd.

(21) Appl. No.: 12/925,322

(22) Filed: Oct. 19, 2010

(51) Int. Cl. F16B 3/00

(52) U.S. Cl. 403/24

(57) ABSTRACT

A cutter mat coupling device includes two or more cutter mats each having a series of indicia and each having a lock member formed on a corner area, and one or more coupling members engaged with the lock members of the cutter mats for coupling the cutter mats together and for preventing the cutter mats from being disengaged from each other, the lock members are lock holes each having a greater inner space and a narrowed neck portion, and the coupling member includes two catches for engaging with the lock holes of the cutter mats and for stably or solidly coupling the cutter mats together and for preventing the cutter mats from being disengaged from each other.

### BACKGROUND OF THE INVENTION

1. Field of the Invention

The present invention relates to a coupling device for coupling two or more cutter mats together, and more particularly to a cutter mat coupling device including a coupling member for stably coupling two or more cutter mats together and for preventing the cutter mats from being disengaged or separated from each other inadvertently.

2. Description of the Prior Art

Typical cutter mats have been developed and provided for being disposed on top of a table surface and for supporting the paper sheets to be cut with knife blades or the like.

For example, U.S. Pat. No. 4,192,494 to Mima discloses one of the typical cutter mats and method of making the same and comprising a base plate of hard synthetic resin for use as a cushion or support to be laid under a sheet of paper or synthetic resin when the sheet is cut or cut off by a cutter.

However, the base plate includes a predetermined size or area or dimension and may not be coupled to the other base plates or mats or pads such that the paper sheet of a greater size or area or dimension may not be suitably cushioned or supported with the single base plate.

U.S. Pat. No. 7,250,207 to Heal et al. discloses another typical table pad coupling system comprising a first table pad having a plurality of peripheral surfaces, and a second table pad also having a plurality of peripheral surfaces, and a number of magnets disposed or engaged into the table pads at or close to the peripheral surfaces for attracting or coupling the peripheral surfaces of the table pads together.

However, a number of magnets should be disposed or engaged into each of the table pads such that the manufacturing cost for the typical table pad coupling system will be greatly increased. In addition, the table pads may have a good chance to be disengaged or separated from each other inadvertently when either of the table pads is contacted or touched or knocked by the other objects or persons.

The present invention has arisen to mitigate and/or obviate the afore-described disadvantages of the conventional cutter mat coupling devices.

### SUMMARY OF THE INVENTION

The primary objective of the present invention is to provide a cutter mat coupling device including a coupling member for stably coupling two or more cutter mats together and for preventing the cutter mats from being disengaged or separated from each other inadvertently.

In accordance with one aspect of the invention, there is provided a cutter mat coupling device comprising a first cutter mat and a second cutter mat each including a series of indicia provided on a peripheral edge thereof, and each including at least one corner area having a lock member provided therein, and at least one coupling member engaged with the lock members of the cutter mats for stably or solidly coupling the cutter mats together and for preventing the cutter mats from being disengaged from each other inadvertently.

The lock members are preferably in the form of the lock holes formed and provided in the cutter mats, and the coupling member includes at least two catches extended outwardly therefrom for engaging with the lock holes of the cutter mats and for stably coupling the cutter mats together.

The lock holes of the cutter mats each include a greater inner space and a narrowed neck portion, and the catches of the coupling member each include a greater outer catch member and a narrowed neck portion for engaging with the corresponding greater inner spaces and the narrowed neck portions of the cutter mats respectively.

The catches of the coupling member include a thickness similar to that of the cutter mats and flush with the cutter mats for forming a planar structure and for smoothly cushioning or supporting the paper sheets. The cutter mats each include a series of spaced score lines arranged at right angles to each other and formed and provided on the cutter mats respectively. The coupling member preferably includes a U-shaped structure having the two or more catches extended outwardly therefrom.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a cutter mat coupling device in accordance with the present invention;

FIG. 2 is a partial exploded view of the cutter mat coupling device;

FIG. 3 is a top plan schematic view of the cutter mat coupling device; FIG. 4 is a perspective view similar to FIG. 1, illustrating the operation of the cutter mat coupling device;

FIG. 5 is a top plan schematic view illustrating the operation of the cutter mat coupling device; and

FIG. 6 is a further perspective view illustrating the operation of the cutter mat coupling device.

### DETAILED DESCRIPTION OF THE PREFERRED EMBODIMENT

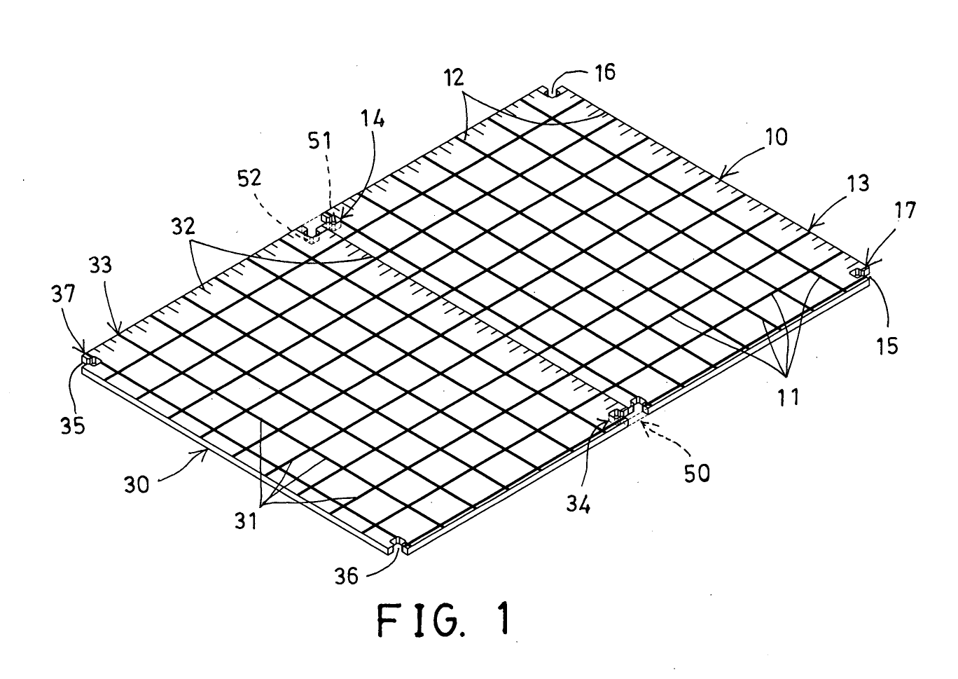

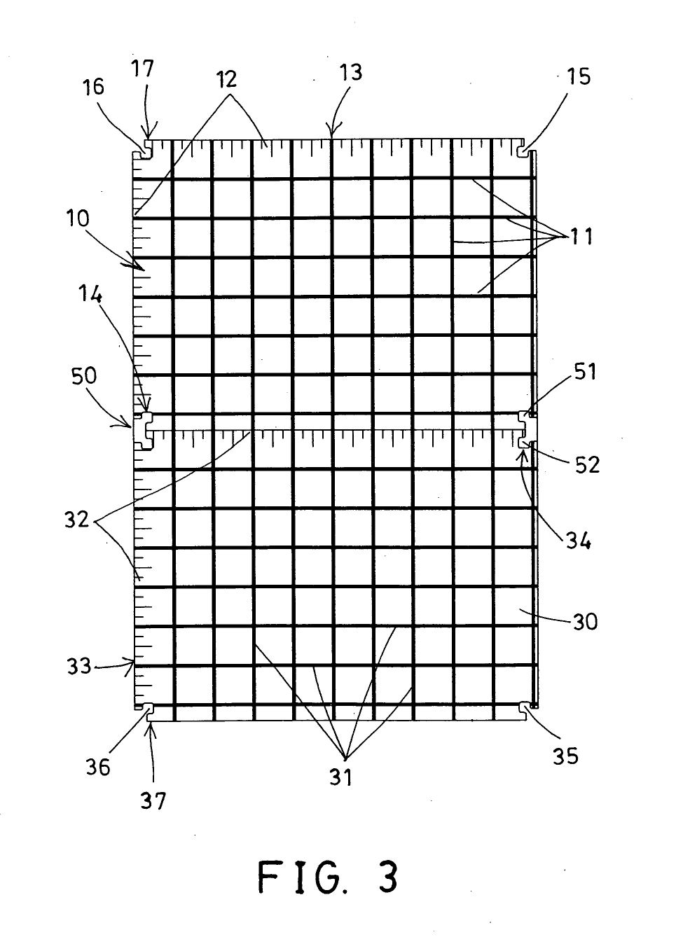

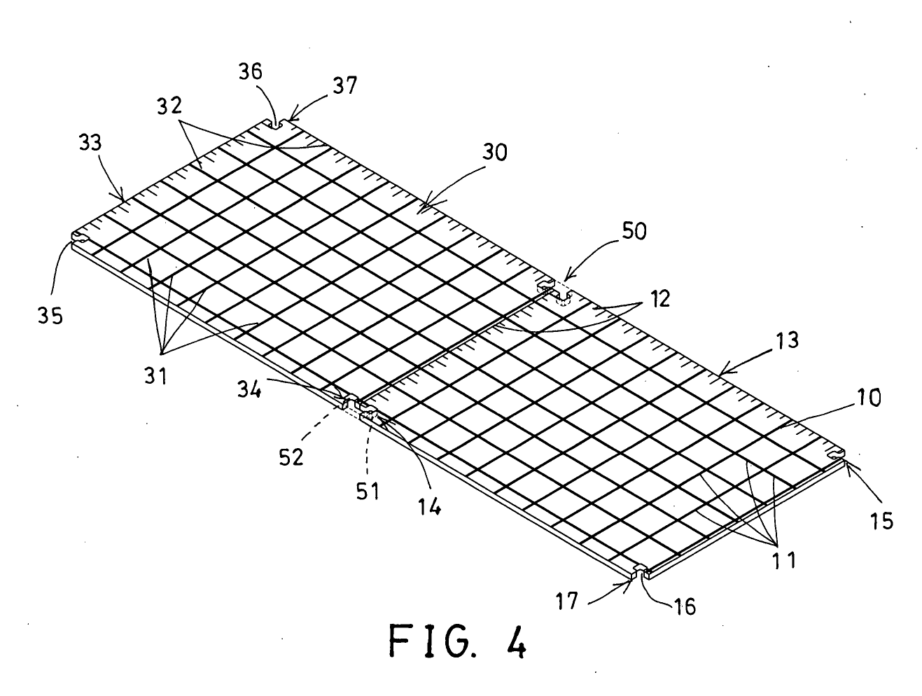

Referring to the drawings, and initially to FIGS. 1-3, a cutter mat coupling system or device in accordance with the present invention comprises two or more table pads or cutter mats 10, 30 each including a series of spaced score lines 11, 31 arranged at right angles to each other and formed or provided on either or both the upper and the bottom surfaces thereof, and each including a series of linear graduations or graduated scale or indicia 12, 32 formed or provided on either or all of the outer peripheral surfaces or edges 13, 33. The above-described structure or configuration for the table pads or cutter mats 10, 30 is typical and is not related to the present invention and will not be described in further details.

The cutter mats 10, 30 each further include four corner areas 14, 34 each having a lock member 15, 35, such as a lock hole 15, 35 formed or provided therein, and the lock holes or lock members 15, 35 each include a wider or greater inner space 16, 36 and a narrowed outer or neck portion 17, 37. The cutter mat coupling device or system in accordance with the present invention further comprises one or more coupling members 50 each including a substantially U-shaped structure and each including two or more coupling legs or fingers or catches 51, 52 extended outwardly therefrom for engaging with the lock members 15, 35 of the cutter mats 10, 30 and for stably coupling the cutter mats 10, 30 together and for preventing the cutter mats 10, 30 from being disengaged or separated from each other inadvertently.

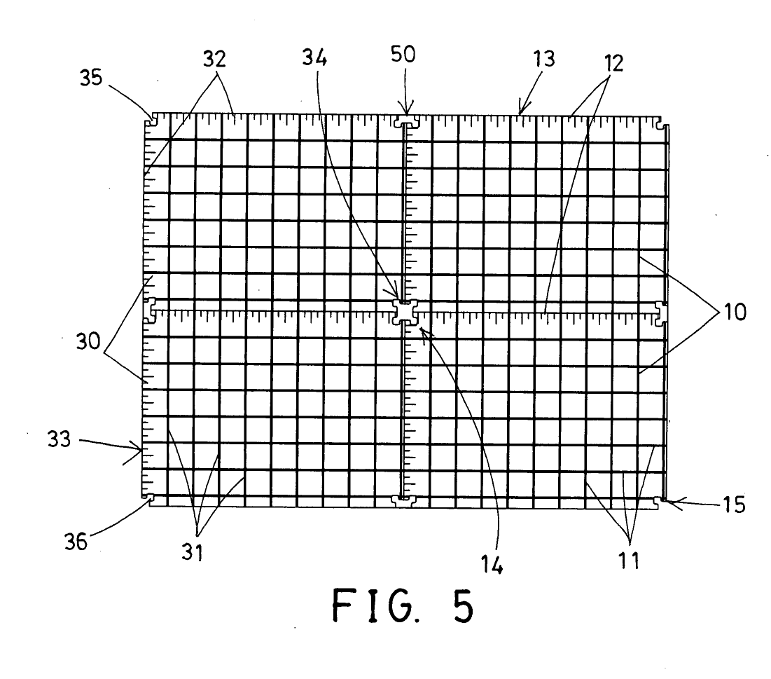

For example, the coupling members 50 each may include two coupling legs or fingers or catches 51, 52 extended outwardly therefrom (FIGS. 1-6), or each may include four coupling legs or fingers or catches 51, 52 extended outwardly therefrom (FIG. 5), and having the shape similar or identical to that of the lock members 15, 35 of the cutter mats 10, 30 for suitably or snugly engaging with the lock members 15, 35 of the cutter mats 10, 30 and for stably or solidly coupling the cutter mats 10, 30 together and for preventing the cutter mats 10, 30 from being disengaged or separated from each other inadvertently.

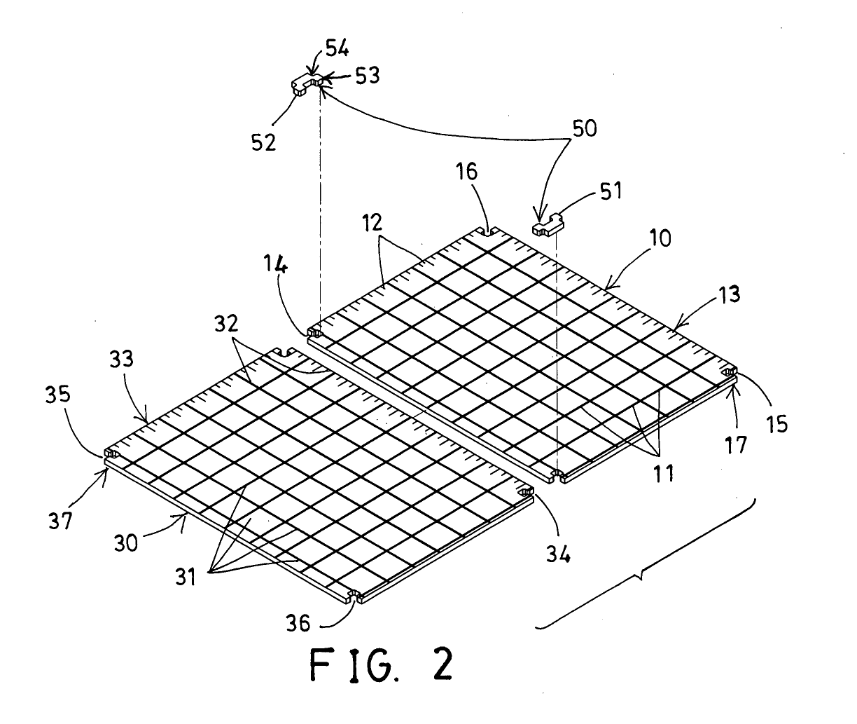

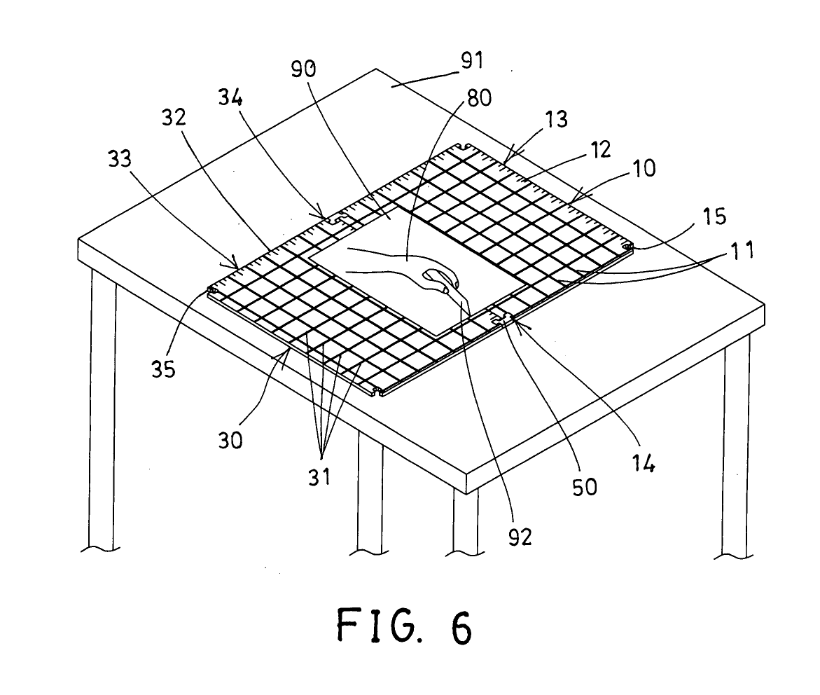

It is to be noted that the catches 51, 52 of the coupling members 50 each include a wider or greater outer catch member 53 and a narrowed neck portion 54 (FIG. 2) for engaging with the wider or greater inner spaces 16, 36 and the narrowed outer or neck portions 17, 37 of the cutter mats 10, 30 respectively and for suitably or snugly engaging with the lock members 15, 35 of the cutter mats 10, 30 and for preventing the cutter mats 10, 30 from being disengaged or separated from each other inadvertently. The catches 51, 52 of the coupling members 50 may include a thickness similar or identical to that of the cutter mats 10, 30 and flush with the cutter mats 10, 30 for allowing the two or more cutter mats 10, 30 that are coupled together to form a planar structure and to smoothly cushion or support the paper sheets 90 (FIG. 6).

In operation, as shown in FIGS. 1-3, the cutter mats 10, 30 may have the longer sides or peripheral surfaces or edges 13, 33 disposed adjacent to each other or contact with each other, or may have the shorter sides or peripheral surfaces or edges 13, 33 disposed adjacent to each other or contact with each other (FIG. 4), or may have three or more cutter mats 10, 30 coupled together to form an even wider or greater planar structure. As shown in FIG. 6, the paper sheet 90 may be suitably cushioned or supported on top of the two or more cutter mats 10, 30 that are coupled together, and the coupled cutter mats 10, 30 may be supported on top of the table top 91, and the user 80 may use the knife or cutter device 92 to suitably cut or trim the paper sheet 90.

Accordingly, the cutter mat coupling device in accordance with the present invention includes a coupling member for stably coupling two or more cutter mats together and for preventing the cutter mats from being disengaged or separated from each other inadvertently.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A cutter mat coupling device comprising:
a first cutter mat and a second cutter mat each including a series of indicia provided on a peripheral edge thereof, and each including at least one corner area having a lock member provided therein, and
at least one coupling member engaged with said lock members of said cutter mats for coupling said first and said second cutter mats together and for preventing said first and said second cutter mats from being disengaged from each other.

2. The cutter mat coupling device as claimed in claim 1, wherein said lock members are lock holes formed and provided in said first and said second cutter mats, and said at least one coupling member includes at least two catches extended outwardly therefrom for engaging with said lock holes of said first and said second cutter mats and for coupling said first and said second cutter mats together.

3. The cutter mat coupling device as claimed in claim 2, wherein said lock holes of said first and said second cutter mats each include a greater inner space and a narrowed neck portion, and said at least two catches of said at least one coupling member each include a greater outer catch member and a narrowed neck portion for engaging with said greater inner spaces and said narrowed neck portions of said first and said second cutter mats respectively.

4. The cutter mat coupling device as claimed in claim 1, wherein said at least two catches of said at least one coupling member include a thickness similar to that of said first and said second cutter mats and flush with said first and said second cutter mats.

5. The cutter mat coupling device as claimed in claim 1, wherein said first and said second cutter mats each include a series of spaced score lines arranged at right angles to each other and formed and provided on said first and said second cutter mats respectively.

6. The cutter mat coupling device as claimed in claim 1, wherein said at least one coupling member includes a U-shaped structure.
